(19) United States
(12) Patent Application Publication
(10) Pub. No.: US 2025/0330463 A1
(43) Pub. Date: Oct. 23, 2025

(54) VIRTUAL LOCAL AREA NETWORK DISCOVERY AND ASSIGNMENT FOR UNAUTHENTICATED OR SLEEPING ENDPOINTS

(71) Applicant: Cisco Technology, Inc., San Jose, CA (US)

(72) Inventors: Sanjay Kumar Hooda, Pleasanton, CA (US); Kedar Sudhir Karmarkar, San Jose, CA (US); Atri Indiresan, Sunnyvale, CA (US); Marc Portoles Comeras, Mountain View, CA (US); Rajagopal Venkatraman, San Jose, CA (US); Raghupathy Sekar, San Jose, CA (US)

(21) Appl. No.: 19/097,761

(22) Filed: Apr. 1, 2025

Related U.S. Application Data
(60) Provisional application No. 63/635,258, filed on Apr. 17, 2024.

(51) Int. Cl. H04L 9/40; H04L 12/46

(52) U.S. Cl. CPC H04L 63/0876; H04L 12/4641

(57) ABSTRACT

Devices, systems, methods, and processes for discovery and assignment for unauthenticated or sleeping endpoints to appropriate VLAN. Typically, unauthenticated endpoints or endpoints that transition into sleep state are assigned to default VLAN. Thus, packets sent from a controller does not reach these endpoints. Therefore, the present disclosure provides a solution for automatic VLAN assignment of endpoints. A network device may detect a packet and upon determination that the packet is associated with a host VLAN, floods the packet on the default VLAN. This way the packet may reach all the endpoints in the default VLAN, including the unauthenticated or sleeping endpoint. The network device may receive a response from the endpoint based on successful reception of the packet. The network device may then assign the endpoint to a correct VLAN based on successful authentication of the endpoint or successful transition of the endpoint to an active mode.

### CROSS-REFERENCE TO RELATED APPLICATIONS

This application claims the benefit of priority to U.S. Provisional Application No. 63/635,258, filed Apr. 17, 2024, the entirety of which is incorporated herein by reference.

### FIELD

The present disclosure relates to network management. More particularly, the present disclosure relates to discovery and assignment for unauthenticated or sleeping endpoints to appropriate Virtual Local Area Network (VLAN).

### BACKGROUND

Virtual Local Area Networks (VLANs) refer to a logical overlay network that groups a subset of devices that share a physical Local Area Network (LAN) together. VLANs segregate the traffic for each group of the subset of devices. VLANs operate at Layer 2 of the OSI model and partition a single switched network into multiple virtual networks to meet different security and functional requirements. VLANs provide traffic isolation for different group of the subset of devices, thus ensuring that only devices of the same VLAN can communicate with each other unless explicitly allowed via Layer 3 routing or Access Control Lists (ACLs). VLANs are also utilized for managing enterprise networks. For example, systems or devices in different departments of an enterprise such as Finance, Information Technology (IT), Human Resources (HR), etc. are configured with their respective VLANs. Likewise, with the increasing utilization of Internet-of-Things (IoT) devices by manufacturing OT customers, VLANs are utilized to enhance security, manage network traffic, and optimize network performance. For example, IoT devices such as sensors, smart cameras, connected appliances, or the like are often configured in their respective VLANs, such that network traffic may be segregated from other types of network traffic.

The IoT endpoints often have static IP addresses and function as silent hosts. In an IoT network, a silent host may refer to an endpoint that is connected to the network but does not actively communicate or transmit data regularly. The silent hosts remain idle or “silent” for extended periods and only transmit data under specific conditions, such as upon detecting a particular event or upon requiring attention. Such an endpoint typically responds to packets sourced from a server (for example, an IoT server), which may reside multiple layers deep within the network architecture. To facilitate this communication between the endpoint and the server, the endpoint is first required to be authenticated, as authentication is required to place the endpoint into the correct VLAN. Without being in the appropriate VLAN, the endpoint may be unable to respond to the server's requests. This scenario introduces a circular dependency: for the endpoint to be authenticated and assigned to the correct VLAN, the endpoint must respond to an authentication request. However, as a silent host, the endpoint does not respond unless the endpoint is already in the correct VLAN. This creates a bottleneck in operating the silent endpoints in an IoT network.

Similar to the IoT scenario, enterprise network devices (such as desktops, thin clients, etc.) are often configured into different VLANs to meet specific functional or organizational requirements. During non-office hours, these enterprise network devices may enter a sleep state when employees log out. For security purposes, these sleeping network devices are moved from their respective host VLANs (also referred to as authenticated VLAN) to a default VLAN. This transition creates a challenge when a network administrator attempts to remotely access these sleeping devices during non-office hours for specific tasks (such as software upgrades, security patch updates, etc.) using wake-up packets (such as a Wake-On-LAN “WOL”, etc.). Due to VLAN mismatch, the wake-up packets do not reach the desired devices, and the wake-up packets fail to activate the sleeping devices.

### SUMMARY OF THE DISCLOSURE

Systems and methods for discovery and assignment for unauthenticated or sleeping endpoints to appropriate Virtual Local Area Network (VLAN) in accordance with embodiments of the disclosure are described herein. In many embodiments, a network device, comprising a processor, a plurality of interfaces including at least one first interface assigned to a host Virtual Local Area Network (VLAN), one or more second interfaces assigned to a default VLAN, and a memory communicatively coupled to the processor, is provided. A second interface of the one or more second interfaces is communicatively coupled to an endpoint that is unauthenticated. The memory comprises a configuration logic that is configured to detect a packet, determine that the packet is associated with the host VLAN, and flood the packet on the default VLAN based on the determination that the packet is associated with the host VLAN. Based on the flooding, the packet reaches the endpoint that is unauthenticated.

In a variety of embodiments, the configuration logic is further configured to receive a response from the endpoint based on the packet reaching the endpoint.

In a number of embodiments, the configuration logic is further configured to transmit an authentication request for the endpoint to an authentication server.

In more embodiments, the authentication request is based on MAC-Address Authentication Bypass (MAB).

In additional embodiments, the configuration logic is further configured to receive, in response to the transmitted authentication request, an authentication response from the authentication server.

In further embodiments, the authentication response is configured to indicate one of a successful authentication of the endpoint or a failed authentication of the endpoint.

In still more embodiments, the configuration logic is further configured to assign the second interface to the host VLAN based on the authentication response indicating the successful authentication of the endpoint.

In still further embodiments, the endpoint is a silent host, incapable of initiating communication until prompted by an external trigger.

In still additional embodiments, the packet corresponds to one of a unicast packet, a broadcast packet, or a Wake-on-LAN (WOL) packet.

In yet more embodiments, detecting the packet comprises snooping an Address Resolution Protocol (ARP)-based packet.

In still yet more embodiments, detecting the packet comprises snooping the packet based on an Access Control List (ACL).

In many further embodiments, prior to detecting, the configuration logic is further configured to receive the packet from an upstream network device.

In many additional embodiments, the detected packet is a locally generated packet at the network device.

In still yet further embodiments, the configuration logic is further configured to transmit the packet on the host VLAN.

In still yet additional embodiments, the host VLAN is an authenticated VLAN and the default VLAN is an unauthenticated VLAN.

In several embodiments, a network device, comprising a processor, a plurality of interfaces including at least one first interface assigned to a host Virtual Local Area Network (VLAN), one or more second interfaces assigned to a default VLAN, and a memory communicatively coupled to the processor, is provided. A second interface of the one or more second interfaces is communicatively coupled to an endpoint that is in a sleep mode. The memory comprises a configuration logic that is configured to detect a packet, determine that the packet is associated with the host VLAN, and flood the packet on the default VLAN based on the determination that the packet is associated with the host VLAN. Based on the flooding the packet reaches the endpoint that is in the sleep mode.

In several more embodiments, the packet is configured to transition the endpoint from the sleep mode to an active mode.

In numerous embodiments, the configuration logic is further configured to receive a response from the endpoint that is transitioned to the active mode, and assign the second interface to the host VLAN based on the response.

In numerous additional embodiments, the endpoint is an 802.1X-enabled device.

In further additional embodiments, a method, comprising detecting a packet, determining that the packet is associated with a host Virtual Local Area Network (VLAN) to which at least one first interface of a network device is assigned, and flooding the packet on a default VLAN based on the determination that the packet is associated with the host VLAN. One or more second interfaces of the network device are assigned to the default VLAN and a second interface of the one or more second interfaces is communicatively coupled to an endpoint that is one of unauthenticated or in a sleep mode. Based on the flooding the packet reaches the endpoint.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration depicting a network environment for the management of a plurality of Virtual Local Area Networks (VLANs) by a network device in accordance with various embodiments of the disclosure;

FIG. 2 is a conceptual illustration depicting a network environment for VLAN discovery and assignment for an endpoint in accordance with various embodiments of the disclosure;

FIG. 3 is a conceptual illustration depicting a network environment for VLAN discovery and assignment for an endpoint in accordance with various embodiments of the disclosure;

FIG. 4 is a flowchart showing a process for VLAN assignment for an unauthenticated endpoint in accordance with various embodiments of the disclosure;

FIG. 5 is a flowchart showing a process for VLAN assignment for an unauthenticated endpoint in accordance with various embodiments of the disclosure;

FIG. 6 is a flowchart showing a process for VLAN assignment for a sleeping endpoint in accordance with various embodiments of the disclosure;

FIG. 7 is a flowchart showing a process for VLAN discovery by an endpoint in accordance with various embodiments of the disclosure; and

FIG. 8 is a conceptual block diagram of a device suitable for setup with a configuration logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide a solution for Virtual Local Area Network (VLAN) discovery and assignment for unauthenticated or sleeping endpoints. Typically, enterprise networks use VLAN to create logical segmentation by dividing a large enterprise network into smaller, isolated networks to reduce broadcast domains. These smaller VLAN networks are created to segregate network traffic belonging to different departments or catering to specific functions. The endpoints of these VLANs may refer to end devices such as desktops, thin clients, printers, cameras, Internet-of-Things (IoT) devices, or the like that may be part of a particular VLAN. In certain scenarios, the endpoints may be unauthenticated. Considering an example scenario, IoT endpoints usually remain idle on the network (thus referred to as silent hosts) for extended periods of time as the IoT endpoints only transmit data under certain conditions, such as when the IoT endpoints detect a specific event or when triggered by some external signal. For example, an IoT endpoint may respond to packets sourced from a server (for example, an IoT server or controller), which may reside multiple layers deep within the network architecture. To facilitate this communication between the IoT endpoint and the server, the IoT endpoint is first required to be authenticated, as authentication is required to place the IoT endpoint into the correct VLAN. Without being in the appropriate VLAN, the IoT endpoint may be unable to respond to the server's requests. This scenario introduces a circular dependency: for the IoT endpoint to be authenticated and assigned to the correct VLAN, the IoT endpoint must respond to an authentication request. However, as a silent host, the IoT endpoint does not respond unless the IoT endpoint is already in the correct VLAN. Currently, the IoT endpoints need to be manually configured and authenticated to be assigned to the correct VLAN. However, manual configuration may be error prone and requires manual attention, which can lead to productivity loss.

Similarly, enterprise network devices such as desktops, thin clients, printers, etc. may be configured to operate in different VLANs based on specific functional or organizational requirements. During non-office hours, employees may log out of their devices, and the devices may automatically enter into a sleep state. For security reasons, the sleeping devices may be moved from their respective host VLANs, referred to as authenticated VLAN, to a default VLAN. In certain scenarios, during non-office hours (such as over weekends) network administrators may require access to these sleeping devices, for example, for software upgrades, security patch updates, or the like. The network administrators may use wake-up packets (such as a Wake-On-LAN “WOL”, etc.) remotely from a server (such as WOL servers) to wake these sleeping devices and start the software updates. However, due to VLAN mismatch (as the sleeping devices are assigned to the default VLAN), the wake-up packets do not reach the desired devices and fail to wake them. Therefore, there is a need to provide wake-up packets or other data packets to the sleeping endpoints or silent endpoints for placing them in correct VLANs.

To overcome these issues, the present disclosure provides a solution implemented at network devices for remote configuration and management of sleeping or unauthenticated endpoints to an appropriate VLAN. The network devices may include a switch having a plurality of interfaces, such as ports, for example. A switch can have multiple VLANs configured on its different ports by assigning each port to a specific VLAN. Each of the VLANs may operate as an isolated network such that the devices in one VLAN may be unable to communicate with devices in another VLAN unless a router or a Layer 3 switch facilitates communication (Inter-VLAN Routing). In an example scenario, one or more first interfaces (or ports) of the switch may be assigned to a host VLAN, whereas one or more second interfaces (or ports) of the switch may be assigned to a default VLAN. One or more endpoints connected to the first interface may get assigned to the host VLAN and become part of the same broadcast domain. Likewise, one or more endpoints connected to the second interface may get assigned to the default VLAN and become part of the same broadcast domain. The host VLAN may refer to a VLAN that serves a specific group of endpoints (e.g., authenticated or active endpoints) connected to the switch. The default VLAN may refer to a VLAN that serves a specific group of endpoints (e.g., unauthenticated or sleeping endpoints) connected to the switch. When a switch is first powered on or reset, all the interfaces of the switch may automatically be assigned to the default VLAN. Likewise, when a new endpoint, which is not yet configured, is plugged into an interface of the switch, the new endpoint is assigned to the default VLAN.

In many embodiments, the host VLAN may be an authenticated VLAN, whereas the default VLAN may refer to a pre-authentication VLAN. Thus, any endpoint when first connected to the switch may be unauthenticated, and thus may be communicatively coupled to an interface of the switch that is assigned to the default VLAN. In a variety of embodiments, an already connected and authenticated endpoint may also be assigned to the default VLAN due to system reboot, faulty endpoint being replaced with a new endpoint, or other such issues.

In further embodiments, the switch may detect a packet. In example, the detected packet may be a unicast packet, a broadcast packet, a Wake-on-LAN (WOL) packet received from a server such as an application server, IoT server, WOL server, or the like. In more embodiments, the packet may be an Address Resolution Protocol (ARP)-based packet, and detecting the packet may include snooping the ARP-based packet. For example, the switch may maintain a Media Access Control (MAC) address table that maps MAC addresses to specific switch ports. In many scenarios, the switch may not have MAC entries associated with unauthenticated endpoints. In many additional scenarios, if an endpoint has stopped sending traffic, a MAC entry for such endpoint may be forgotten or “aged out”. Therefore, the switch may snoop ARP-based packets received from upstream routers or locally generated. In yet more embodiments, detecting the packet may include snooping the packet based on an Access Control List (ACL).

Upon detecting the packet, the switch may determine whether the packet is associated with the host VLAN. Upon determining that the packet is associated with the host VLAN, the switch may flood the packet on the default VLAN, and also transmit the packet on the host VLAN. As a result, the packet may reach all endpoints (such as silent endpoints, unauthenticated endpoints, sleeping endpoints, etc.) in the default VLAN as well as authenticated endpoints operating on the host VLAN. In still yet more embodiments, the switch may receive a response from an endpoint, coupled to a second interface of the one or more second interfaces assigned to the default VLAN, based on the packet reaching the endpoint.

In many further embodiments, the endpoint from which the response is received may be an unauthenticated endpoint. For example, the endpoint may be a silent host, incapable of initiating communication until prompted by an external trigger. In such a scenario, the switch may transmit an authentication request for the endpoint to an authentication server (for example, a Remote Authentication Dial-In User Service server, an Identity Services Engine, or the like). Considering an example scenario of an IoT network, in many additional embodiments, the switch may use MAC-Address Authentication Bypass (MAB) for transmitting the authentication request. In still yet further embodiments, the switch may receive an authentication response indicating either a successful authentication of the endpoint or a failed authentication of the endpoint. Upon successful authentication of the endpoint, the switch may assign the second interface, communicatively coupled to the endpoint, to the host VLAN. In several embodiments, the endpoint may be an authenticated endpoint that is in a sleep mode. Thus, the endpoint upon receiving the flooded packet may transition from the sleep mode to an active mode, and transmit the response to the switch. The switch, based on receiving the response from the endpoint, may assign the second interface to the host VLAN. Thus, the solution described in the present disclosure provides for discovery, authentication, and assignment of unauthenticated or sleeping endpoints to appropriate VLANs, without requiring manual intervention, thereby simplifying the management of networks.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

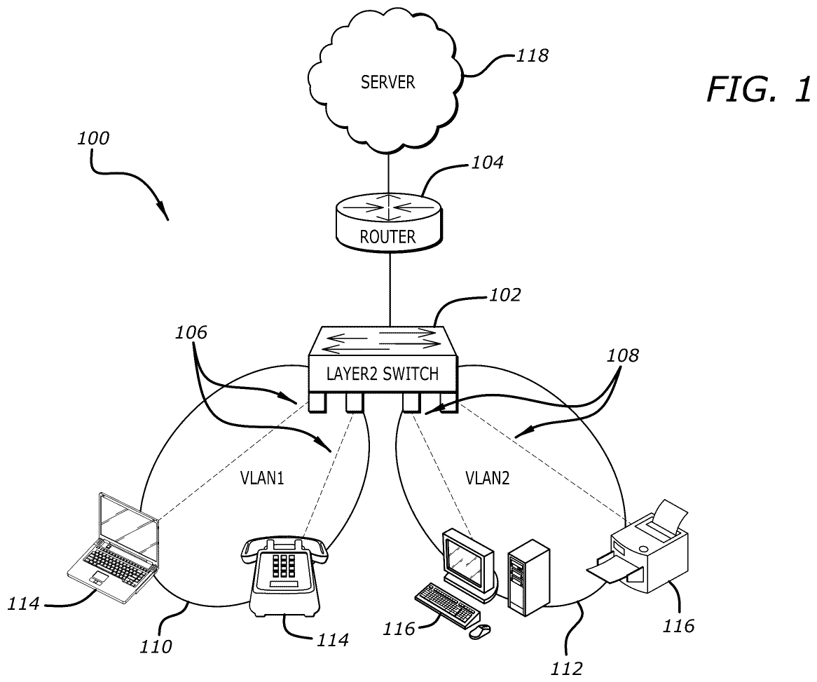

Referring to FIG. 1, a conceptual illustration depicting a network environment 100 for the management of a plurality of Virtual Local Area Networks (VLANs) by a network device in accordance with various embodiments of the disclosure is shown. As depicted in FIG. 1, in many embodiments, a Layer 2 switch 102 (hereinafter referred to as “the switch 102”) may be communicatively coupled with a router 104 (for example, operating at Layer 3). In a number of embodiments, the router 104 may be connected to a server 118, such as an application server, a Wake-on-LAN (WOL server), a network cloud, or the like. In more embodiments, the switch 102 may have a first plurality of interfaces 106 and a second plurality of interfaces 108. The first and second plurality of interfaces 106, 108 may serve as ingress and egress ports that facilitate the flow of network traffic via the switch 102.

In additional embodiments, the switch 102 may have a plurality of VLANs configured on different interfaces 106, 108. For example, in an enterprise network, multiple VLANs may be configured to enhance traffic management, security, and network segmentation. By logically partitioning a physical network into multiple VLANs, broadcast domains can be isolated, thus reducing congestion and improving network performance. Each VLAN may function as an independent subnet, allowing for granular control over the network traffic, such as routing between intra-department devices or restricting communication between sensitive systems and general users. In addition, having multiple VLANs may also bolster security by enforcing policy-based access controls, ensuring that only authorized devices can access specific network resources. Additionally, having multiple VLANs may simplify network management by enabling centralized configurations and network segmentation based on functional or geographical groupings, without requiring physical hardware changes. In an example scenario, as depicted in FIG. 1, the switch 102 may have a first VLAN 110 “VLAN1” configured on the first plurality of interfaces 106 and a second VLAN 112 “VLAN2” configured on the second plurality of interfaces 108.

In an example, the first VLAN 110 may be a host VLAN and the second VLAN 112 may be a default VLAN. The host VLAN may be an authenticated VLAN that serves a specific group of endpoints belonging to one broadcast domain. In a similar manner, the default VLAN may be a “pre-authentication” VLAN, a pre-configured VLAN, or an unauthenticated VLAN. In numerous embodiments, when the switch 102 is first powered on or reset, all the interfaces (e.g., the first and second plurality of interfaces 106, 108) of the switch 102 may be automatically assigned to the default VLAN. Likewise, when a new endpoint, which is not yet configured or authenticated, is plugged into the switch 102, the new endpoint may be assigned to the default VLAN.

In further embodiments, the first VLAN 110 may have a first plurality of endpoints 114 (such as desktops, thin clients, printers, Internet of Things (IoT) devices, or the like), where each endpoint 114 is communicatively coupled to one of the first plurality of interfaces 106. In still more embodiments, the first plurality of endpoints 114 may refer to authenticated or awake endpoints. For example, the first plurality of endpoints 114 can include desktops, thin clients, or the like of a particular enterprise department. In further examples, the first plurality of endpoints 114 can include IoT devices that may have been authenticated and are assigned to the first VLAN 110.

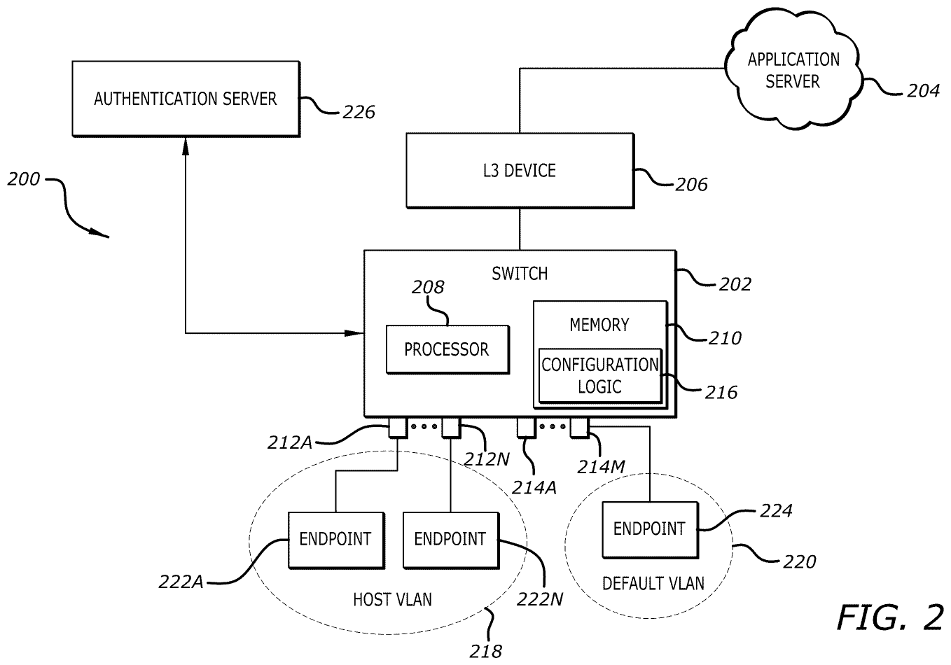

In still further embodiments, the second VLAN 112 may have a second plurality of endpoints 116 (such as desktops, thin clients, printers, IoT devices, or the like), each communicatively coupled to one of the second plurality of interfaces 108. In still additional embodiments, the second plurality of endpoints 116 may include new devices which are still unauthenticated. In further embodiments, the second plurality of endpoints 116 may include one or more devices that have entered into a sleep mode, and thus are re-assigned to the second VLAN 112 from the first VLAN 110, for security reasons, for example. In one or more embodiments, the switch 102 may be configured to dynamically assign one or more of the second plurality of interfaces 108 to the first VLAN 110 based on the authentication or waking up of corresponding endpoints 116. Dynamic assignment of the one or more of the second plurality of interfaces 108 to the first VLAN 110 is described in detail in conjunction with FIGS. 2-7.

Although a specific embodiment showing a network environment for the management of a plurality of VLANs by a switch suitable for carrying out the various steps, processes, methods, and operations described herein is discussed with respect to FIG. 1, any of a variety of systems and/or processes may be utilized in accordance with embodiments of the disclosure. In several more embodiments, the router 104 can be replaced with a Layer-3 switch, especially for routing traffic within an enterprise network, for example, between different buildings or floors connected via a Local Area Network (LAN). The elements depicted in FIG. 1 may also be interchangeable with other elements of FIGS. 2-8 as required to realize a particularly desired embodiment.

Referring to FIG. 2, a conceptual illustration depicting a network environment 200 for VLAN discovery and assignment for an endpoint in accordance with various embodiments of the disclosure is shown. In many embodiments, as depicted by FIG. 2, a switch 202 and an application server 204 may be connected to each other via a Layer 3 (L3) device 206. Examples of the application server 204 may include Internet-of-Thing (IoT) server, Wake-on-LAN (WOL) server, a manufacturing customer server, network cloud, or any other remote server. In a number of embodiments, the L3 device 206 may be a router, an L3 switch, software-based router (such as router on a server), or the like.

In a variety of embodiments, the switch 202 may include a processor 208, a memory 210, a plurality of first interface 212A-212N, and a plurality of second interface 214A-214M, among other internal components. In a number of embodiments, the processor 208 may be implemented as one or more microprocessors, microcomputers, microcontrollers, digital signal processors, central processing units, logic circuitries, and/or any devices that process data based on operational instructions. Among other capabilities, the processor 208 may be configured to fetch and execute computer-readable instructions stored in the memory 210. Further examples of the processor 208 may include Application-Specific Integrated Circuit (ASIC) processors, Reduced Instruction Set Computing (RISC) processors, Complex Instruction Set Computing (CISC) processors, Field-Programmable Gate Arrays (FPGAs), Digital Signal Processor (DSPs), or the like.

In more embodiments, the memory 210 may be coupled to the processor 208. The memory 210 may be configured to store one or more computer-readable instructions or routines in a non-transitory computer-readable storage medium, which may be fetched and executed by the processor 208. The memory 210 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memory 210 in the switch 202 as described herein. In several embodiments, the memory 210 may be realized in the form of a database server or a cloud storage working in conjunction with the switch 202 without departing from the scope of the disclosure.

In additional embodiments, the plurality of first interface 212A-212N and the plurality of second interface 214A-214M may include suitable logic, circuitry, interfaces, and/or code, executable by the circuitry, which may be configured to perform one or more operations associated with transmitting and receiving data/signals. The plurality of the first interface 212A-212N and the plurality of the second interface 214A-214M may function as ingress or egress ports of the switch 202.

In further embodiments, the memory 210 may include a configuration logic 216. The configuration logic 216 may include instructions, such as a set of codes, to execute VLAN assignment for various interfaces (such as the plurality of first interface 212A-212N and the plurality of second interface 214A-214M) of the switch 202. In still more embodiments, the configuration logic 216 may assign the plurality of first interfaces 212A-212N to a host VLAN 218. The plurality of first interfaces 212A-212N may be communicatively coupled to endpoints 222A-222N. The endpoints 222A-222N may include devices such as desktops, IoT devices, thin clients, printers, or the like that may have been authenticated to operate on the host VLAN 218.

In a similar manner, the configuration logic 216 may assign the plurality of second interfaces 214A-214M to a default VLAN 220. For example, as shown in FIG. 2, the configuration logic 216 may assign at least one second interface 214M coupled to an endpoint 224, which is unauthenticated, to the default VLAN 220. Considering an example scenario, the endpoint 224 may be an IoT device and thus, may operate as a silent host. An endpoint may refer to a silent host, if the endpoint is incapable of initiating communication until prompted by an external trigger or event. In another example scenario, when a new IoT device, which is unauthenticated, is first plugged into the switch 202, an interface of the switch 202 coupled to the new unauthenticated IoT device may get assigned to the default VLAN 220. In additional scenarios, if a connected endpoint becomes faulty and is replaced with a new IoT device, an interface coupled to the new IoT device may be reset to the default VLAN 220 by the configuration logic 216.

In many further embodiments, the L3 device 206 may receive a packet from the application server 204. The application server 204 may refer to an IoT controller, WOL server, or the like. In numerous embodiments, the packet may be a unicast packet, a broadcast packet, or the like. In numerous additional embodiments, the packet may refer to a Wake-on-LAN (WOL) packet (also known as magic packet), or other such wake-up packets. The L3 device 206 upon receiving the packet, may generate an Address Resolution Protocol (ARP) request. In still further embodiments, the L3 device 206 may transmit the ARP request to the switch 202. In many embodiments, the ARP request may be transmitted as a broadcast packet to the switch 202. For example, the ARP request may be transmitted to the broadcast MAC address FF:FF:FF:FF:FF:FF. In further embodiments, the ARP request may be transmitted as a unicast packet to the switch 202. Typically, ARP requests can be used to wake an endpoint in sleeping, standby, or shut down mode. In further examples, ARP requests can be used to wake a silent host.

In yet more embodiments, the switch 202 may detect or snoop the ARP request packet. The switch 202 may determine the Internet Protocol (IP) address contained within the ARP request packet. In many additional embodiments, the switch 202 may determine whether the ARP request packet is associated with the host VLAN 218 or not. For example, based on the IP address included in the ARP request packet, the switch 202 may determine if the IP address is associated with the host VLAN 218 or not. Based on the determination that the ARP request packet is associated with the host VLAN 218, in many further embodiments, the switch 202 may flood the packet on the default VLAN 220. Flooding may refer to a process where a switch transmits or broadcasts a packet to all ports or interfaces within a particular VLAN. Thus, the detected packet reaches the unauthenticated endpoint 224 in the default VLAN 220. In one or more embodiments, the switch 202 may further transmit the detected packet on the host VLAN 218. As a result, all endpoints, such as authenticated endpoints 222A-222N in the host VLAN 218 receive the transmitted packet.

In yet more embodiments, the switch 202 may receive a response from the endpoint 224 based on the flooded packet reaching the endpoint 224. In an example, the received response may include a MAC address of the endpoint 224. In still yet further embodiments, the switch 202 may transmit an authentication request for the endpoint 224 to an authentication server 226. Examples of the authentication server 226 may include a Remote Authentication Dial-In User Service (RADIUS) server, an Identity Services Engine (ISE), an Identity Provider (IdP), an Authentication, Authorization, and Accounting (AAA) Server, or the like. Considering the above example of the IoT network, in many additional embodiments, the switch 202 may utilize MAC-Address Authentication Bypass (MAB) to transmit the authentication request. MAB may refer to a method used in network security where a device is authenticated based on its MAC address rather than traditional credentials such as usernames and passwords. MAB may be used for devices that do not support 802.1X authentication, such as printers, IP cameras, or IoT devices. Thus, the authentication request transmitted to the authentication server 226 may include a MAC address of the endpoint 224.

In still yet further embodiments, the switch 202 may receive an authentication response from the authentication server 226 indicating either a successful authentication or a failed authentication of the endpoint 224. Upon successful authentication of the endpoint 224, in several embodiments, the configuration logic 216 may be configured to assign the corresponding second interface 214M, communicatively coupled to the endpoint 224, to the host VLAN 218.

In another example scenario, the endpoint 224 may be an employee's desktop, a thin client, or the like, connected as a wired endpoint and operating in the host VLAN 218 during working hours or when active. During non-working hours, when the employee logs out of the endpoint 224, the endpoint 224 may automatically enter into sleep mode. As a result, the configuration logic 216 may re-assign the endpoint 224 from the host VLAN 218 to the default VLAN 220. The application server 204 (such as Wake-on-LAN “WOL” server, network cloud, etc.) may require to access the endpoint 224, typically during non-office hours, for software upgrades, security patch updates, or the like. In yet more embodiments, the application server 204 may transmit a packet (such as a Wake-On-LAN “WOL”, etc.) to wake the endpoint 224. In a similar manner, as explained above for the IoT network scenario, in numerous embodiments, the L3 device 206 may generate an ARP request based on the packet received from the application server 204. In still further embodiments, the L3 device 206 may transmit an ARP request packet to the switch 202, which upon detecting the ARP request packet may determine that it is associated with the host VLAN 218. In several more embodiments, the switch 202 may be configured to flood the ARP request packet on the default VLAN 220 based on the determination that the packet is associated with the host VLAN 218. In numerous embodiments, the endpoint 224 upon receiving the ARP request packet may transition from the sleep mode to an active mode. In numerous additional embodiments, the configuration logic 216 may thus assign the second interface 214M, communicatively coupled to the endpoint 224 to the host VLAN 218.

Although a specific embodiment showing a network environment for VLAN discovery and assignment for an endpoint suitable for carrying out the various steps, processes, methods, and operations described herein is discussed with respect to FIG. 2, any of a variety of systems and/or processes may be utilized in accordance with embodiments of the disclosure. In several embodiments, if the IP address of the endpoint is known, the application server 204 may transmit a unicast WOL packet to wake up a specific endpoint. The elements depicted in FIG. 2 may also be interchangeable with other elements of FIGS. 1 and 3-8 as required to realize a particularly desired embodiment.

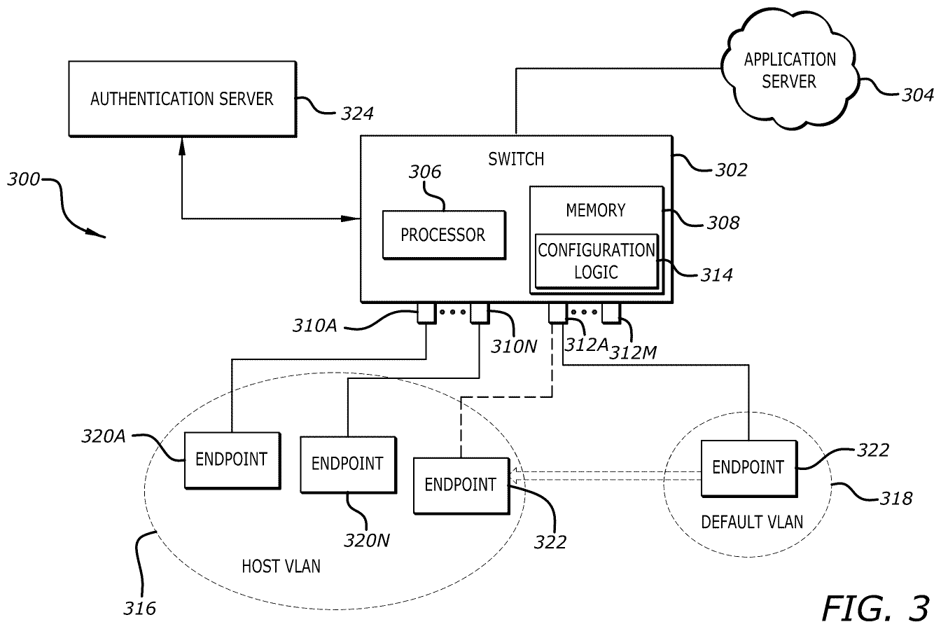

Referring to FIG. 3, a conceptual illustration depicting a network environment 300 for VLAN discovery and assignment for an endpoint in accordance with various embodiments of the disclosure is shown. As depicted by FIG. 3, a switch 302 and an application server 304 may be connected to each other. Examples of the application server 304 may include IoT server, Wake-WOL server, network administrator server, or any other remote server.

In a variety of embodiments, the switch 302 may include a processor 306, a memory 308, a plurality of first interface 310A-310N, and a plurality of second interface 312A-312M, among other internal components. In a number of embodiments, the processor 306 may be implemented as one or more microprocessors, microcomputers, microcontrollers, digital signal processors, central processing units, logic circuitries, and/or any devices that process data based on operational instructions. Among other capabilities, the processor 306 may be configured to fetch and execute computer-readable instructions stored in the memory 308. Further examples of the processor 306 may include ASIC processors, RISC processors, CISC processors, FPGAs, DSPs, or the like.

In more embodiments, the memory 308 may be coupled to the processor 306. The memory 308 may be configured to store one or more computer-readable instructions or routines in a non-transitory computer-readable storage medium, which may be fetched and executed by the processor 306. The memory 308 may include any non-transitory storage device including, for example, volatile memory such as RAM, a ROM, or non-volatile memory such as EPROM, an HDD, a flash memory, a solid-state memory, and the like. It will be apparent to a person skilled in the art that the scope of the disclosure is not limited to realizing the memory 308 in the switch 302 as described herein. In several embodiments, the memory 308 may be realized in the form of a database server or a cloud storage working in conjunction with the switch 302 without departing from the scope of the disclosure.

In additional embodiments, the plurality of first interface 310A-310N and the plurality of second interface 312A-312M may include suitable logic, circuitry, interfaces, and/or code, executable by the circuitry, which may be configured to perform one or more operations associated with transmitting and receiving data/signals. The plurality of the first interface 310A-310N and the plurality of the second interface 312A-312M may function as ingress or egress ports of the switch 302.

In further embodiments, the memory 308 may include a configuration logic 314. The configuration logic 314 may include instructions, such as a set of codes, to execute VLAN assignment for various interfaces (such as the plurality of first interface 310A-310N and the plurality of second interface 312A-312M) of the switch 302. In still more embodiments, the configuration logic 314 may assign the plurality of first interfaces 310A-310N to a host VLAN 316. The plurality of first interfaces 310A-310N may be communicatively coupled to endpoints 320A-320N. The endpoints 320A-320N may include devices such as desktops, IoT devices, thin clients, printers, or the like that may be authenticated to operate on the host VLAN 316.

In a similar manner, the configuration logic 314 may assign the plurality of second interfaces 312A-312M to a default VLAN 318. For example, as shown in FIG. 3, the configuration logic 314 may assign at least one second interface 312A coupled to an endpoint 322, which is unauthenticated, to the default VLAN 318. Considering an example scenario, the endpoint 322 may be an IoT device and thus, may operate as a silent host. In another example scenario, when a new IoT device, which is unauthenticated, is first plugged into the switch 302, an interface of the switch 302 coupled to the new unauthenticated IoT device may get assigned to the default VLAN 318. In additional scenarios, if a connected endpoint becomes faulty and is replaced with a new IoT device, an interface coupled to the new IoT device may be reset to the default VLAN 318 by the configuration logic 314.

In further embodiments, the switch 302 may receive a packet (e.g., a broadcast packet or a unicast packet) from the application server 304. The application server 304 may refer to corresponding IoT controller, WOL server, or the like. The packet may refer to WOL packet or any other suitable wake-up packet. In more embodiments, the switch 302 may utilize an Access Control List (ACL) to permit or deny the packet. For example, if the switch 302 is configured to block the broadcast or multicast traffic, the ACL list on the switch 302 may be configured to permit WOL packets from the IoT controller, WOL server, or the like. In yet more embodiments, the switch 302 may detect or snoop the packet based on the ACL list. In many additional embodiments, the switch 302 may determine that the detected packet is associated with the host VLAN 316, and thereafter, may flood the packet on the default VLAN 318. The switch 302 may further transmit the packet on the host VLAN 316. Thus, the packet may reach all endpoints, such as the authenticated endpoints 320A-320N in the host VLAN 316 and the unauthenticated endpoint 322 in the default VLAN 318.

In yet more embodiments, the switch 302 may receive a response from the endpoint 322 based on the flooded packet reaching the endpoint 322. In still yet further embodiments, upon receiving the response of the unauthenticated endpoint 322, the switch 302 may transmit an authentication request for the endpoint 322 to an authentication server 324. In still yet further embodiments, the switch 302 may receive an authentication response indicating either a successful authentication or a failed authentication of the endpoint 322. Upon successful authentication of the endpoint 322, in several embodiments, the configuration logic 314 may re-assign the corresponding second interface 312A, communicatively coupled to the endpoint 322, from the default VLAN 318 to the host VLAN 316, as depicted by dashed line in FIG. 3.

In various embodiments, continuing with the example scenario of an enterprise network of FIG. 2, the endpoint 322 (such as desktop, a thin client, or the like) may enter into a sleep mode during non-working hours. Thus, the interface 312A, communicatively coupled to the endpoint 322, may be reset to the default VLAN 318 from the host VLAN 316. In yet more embodiments, the application server 304 may transmit a WOL packet for the endpoint 322. Thus, the switch 302, based on determination that the packet is permitted as per the ACL list, may transmit the packet on the host VLAN 316 and flood the packet on the default VLAN 318.

In numerous embodiments, the packet may be a WOL unicast packet or an IP directed broadcast packet. In still yet more embodiments, the packet may be received by Switched Virtual Interface (SVI) boundary of the switch 302. An SVI may refer to a logical (or virtual) Layer 3 interface on a network switch that enables inter-VLAN routing and switch management. Thus, an SVI may not correspond to any specific hardware port, but instead operates on the software level. Each VLAN can have one associated SVI and each SVI may be assigned an IP address that serves as the gateway for all the endpoints within that VLAN. In many further embodiments, when the packet reaches the SVI boundary of the switch 302, the switch 302 may determine that the destination IP belongs to a directly connected VLAN or subnet (based on the routing table of the switch 302). Thus, the packet may be punted based on a glean entry at the SVI boundary of the switch 302. A glean entry may refer to a special entry in the Forwarding Information Base (FIB) table that indicates to a switch that there is no specific route available for a particular IP address, however, the destination IP belongs to a subnet directly connected to the SVI. In several embodiments, the switch 302 may convert the packet from a Layer 3 format to a Layer 2 format. Considering an example scenario, the packet can be a WOL packet transmitted as IP Directed Broadcast packet, which is a Layer 3 broadcast packet. When the IP Directed Broadcast packet is received by the SVI boundary of the switch 302, the packet may be converted from the Layer 3 broadcast format into a Layer 2 broadcast format.

In many further embodiments, using the ACL, the packet may be punted to reach the control plane of the switch 302. In further embodiments, the packet may be flooded in the host VLAN 316 as well as in the default VLAN 318. This way, the packet (such as the WOL packet) may reach the endpoint 322.

In several embodiments, the endpoint 322 upon receiving the packet, may transition from the sleep mode to an active mode. In several more embodiments, the switch 302 may receive a response from the endpoint 322 indicating that it has transitioned to the active mode. In numerous embodiments, the configuration logic 314 may then assign the second interface 312A, communicatively coupled to the endpoint 322, to the host VLAN 316 based on the response. In still more embodiments, the endpoint 322 may be an 802.1X-enabled device. Considering the example scenario of the enterprise network, in order to complete the solution of providing the connectivity to the network administrator for software or security patch updates to the endpoints (for example desktops), the default VLAN 318 policy can be setup in a way that only the desktops in the default VLAN 318 can connect to the subnet of the network administrator. In an example scenario, the subnet of the network administrator can be as small as just a few servers.

Although a specific embodiment showing a network environment for VLAN discovery and assignment for an endpoint suitable for carrying out the various steps, processes, methods, and operations described herein is discussed with respect to FIG. 3, any of a variety of systems and/or processes may be utilized in accordance with embodiments of the disclosure. In several more embodiments, the switch 302 may not include an SVI boundary, thus, the packet upon reaching the control plane of the switch 302 may be simply flooded to both the host VLAN 316 and the default VLAN 318. The elements depicted in FIG. 3 may also be interchangeable with other elements of FIGS. 1-2 and 4-8 as required to realize a particularly desired embodiment.

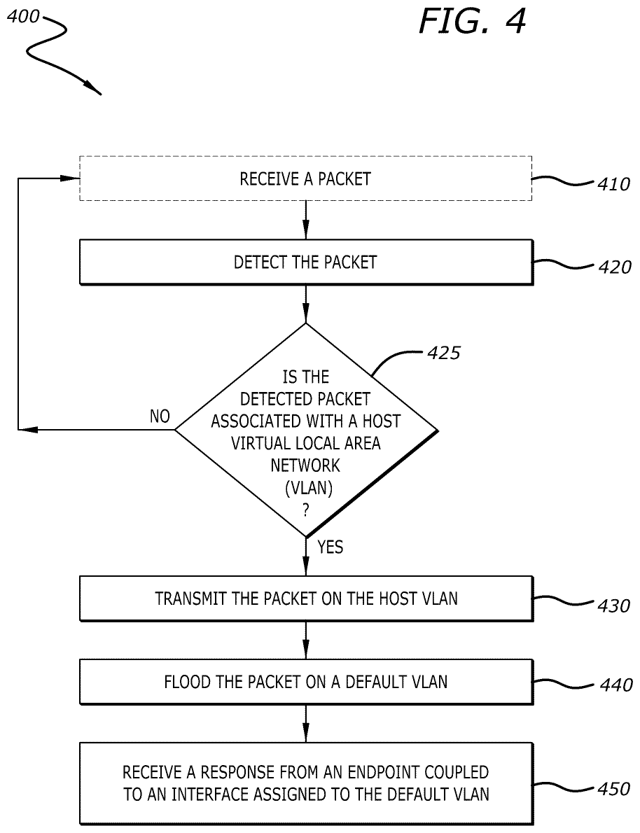

Referring to FIG. 4, a flowchart showing a process 400 for VLAN assignment for an unauthenticated endpoint in accordance with various embodiments of the disclosure is shown. In many embodiments, the process 400 may receive a packet (block 410). For example, the packet may correspond to a WOL packet or any suitable wake-up packet. In a number of embodiments, the process 400 may receive the WOL packet from an application server, a WOL server, an IoT controller, or the like. In numerous embodiments, the process 400 may receive the packet from an upstream network device such as L3 device, such as a Layer 3 switch, router, or the like. In numerous embodiments, the process 400 may receive the packet as a broadcast or a unicast packet.

In more embodiments, the process 400 may detect the packet (block 420). The process 400 may be implemented by a network device (such as a switch). In numerous embodiments, detecting the packet by the process 400 may include snooping an ARP-based packet. The process 400 may snoop ARP-based packets received from upstream devices or locally generated. In still numerous embodiments, detecting the packet by the process 400 may include snooping the packet based on an ACL. The process 400 may be configured to utilize an ACL to permit or deny the packet, for example, the process 400 may be configured to permit a WOL packet from an IoT controller. In various embodiments, the process 400 may detect whether the packet is a wake-up packet corresponding to a specific IoT network, VLAN network, or the like. The process 400 may check whether the packet includes broadcast MAC address, unicast to a specific MAC address, or is an IP directed broadcast packet. This means the packet is sent to a broadcast IP address for a specific subnet (e.g., 192.168.1.255 for the 192.168.1.0/24 network) but retains the broadcast MAC FF:FF:FF:FF:FF:FF. In a variety of embodiments, the process 400 may detect that the packet is a locally generated packet at the network device. For example, the switch may locally generate packet for network management, control, or routing purposes. Considering an example scenario, the switch may generate an ARP request to resolve IP-to-MAC mapping. In another example scenario, a controller (such as an IoT controller, a WOL server, etc.) may send a request to the switch to wake-up an endpoint on the network. Thus, the switch can generate a WOL packet and broadcast it within the VLAN.

In additional embodiments, the process 400 may determine whether the detected packet is associated with a host VLAN (block 425). The process 400 may check the destination MAC address of the packet to determine whether the packet is associated with the host VLAN. In an example scenario, if the packet refers to a WOL packet, it may be received as a broadcast frame that contains a sequence of 6 bytes of FF:FF:FF:FF:FF:FF followed by 16 repetitions of the MAC address of an endpoint (such as a target device). In one or more embodiments, upon determination that the packet is not associated with the host VLAN, the process 400 waits to receive a new packet (block 410).

In still more embodiments, upon determination that the packet is associated with the host VLAN, the process 400 may transmit the packet on the host VLAN (block 430). Endpoints communicatively coupled to one or more interfaces assigned to the host VLAN may be authenticated endpoints. Thus, the process 400, based on the MAC address included in the packet, may transmit (e.g., broadcast or unicast) the packet on the host VLAN, so that the packet reaches all or selective endpoints operating within the host VLAN.

In still further embodiments, the process 400 may flood the packet on a default VLAN (block 440). The default VLAN may refer to a pre-configured VLAN on a network switch that is utilized to group one or more switch ports into a single broadcast domain. When a switch is first powered on or reset, all the interfaces of the switch may be automatically assigned to the default VLAN. Likewise, when a new endpoint, which is not yet configured or authenticated, is connected to the switch, an interface of the switch connected to the new endpoint may be assigned to the default VLAN. In other words, the default VLAN can also be referred to as pre-authentication VLAN. In many embodiments, the process 400 may determine whether the packet is associated with the host VLAN. The process 400 may then flood the packet (for example, WOL packet) on the default VLAN, and may also transmit the packet on the host VLAN. The process 400 upon receiving the packet (for example, WOL packet) associated with the host VLAN, may flood the packet on the default VLAN. This way, the packet may reach endpoints (e.g., endpoints that may not be yet authenticated, configured, or may have entered into sleep mode, shutdown mode, or the like) within the default VLAN.

In still additional embodiments, the process 400 may receive a response from an endpoint coupled to an interface assigned to the default VLAN (block 450). In an example scenario, upon flooding the packet in the default VLAN, the packet may reach all endpoints in the default VLAN. This way the packet reaches the unauthenticated silent host, which may be triggered to respond to the connected switch. Thus, the process 400 may receive the response from the endpoint coupled to the interface assigned to the default VLAN. In several embodiments, the process 400 may accordingly authenticate the endpoint and may assign the interface coupled to the endpoint to an appropriate host VLAN.

Although a specific embodiment showing a process for VLAN assignment for an unauthenticated endpoint suitable for carrying out the various steps, processes, methods, and operations described herein is discussed with respect to FIG. 4, any of a variety of systems and/or processes may be utilized in accordance with embodiments of the disclosure. In still more embodiments, the process 400 may receive an IP-directed WOL packet, which is received from a Layer 3 device or a remote network. For example, a remote server may generate a WOL packet with the MAC address of the endpoint. This packet may then be encapsulated as a unicast Layer 3 IP packet (instead of broadcast) and sent to a router or switch on the destination subnet. The elements depicted in FIG. 4 may also be interchangeable with other elements of FIGS. 1-3 and 5-8 as required to realize a particularly desired embodiment.

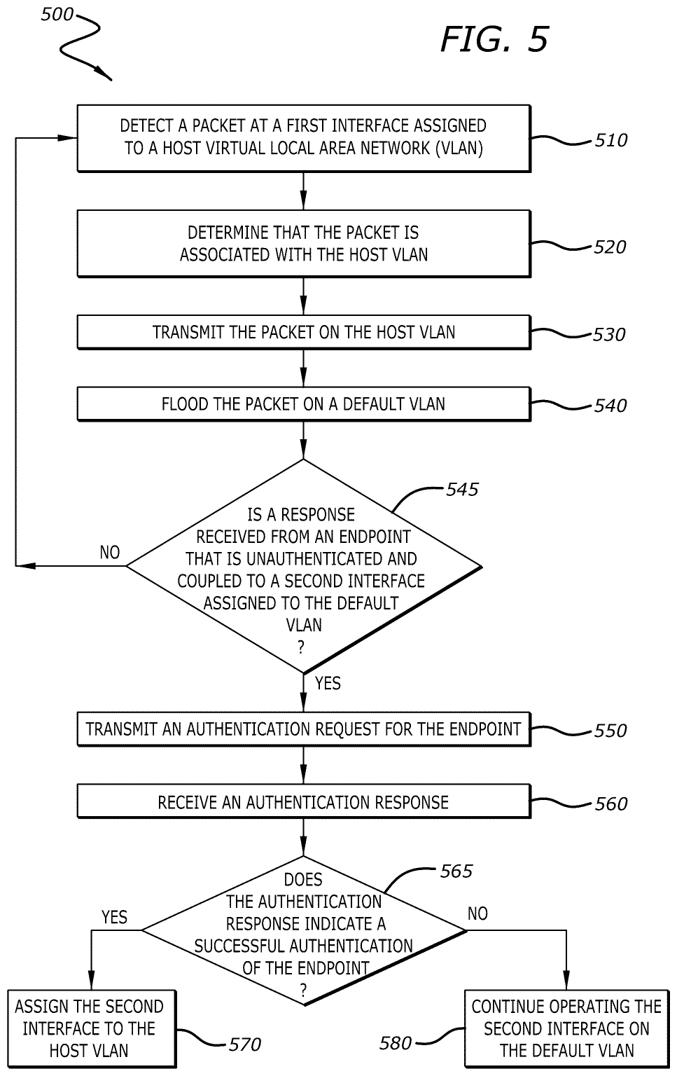

Referring to FIG. 5, a flowchart showing a process 500 for VLAN assignment for an unauthenticated endpoint in accordance with various embodiments of the disclosure is shown. In many embodiments, the process 500 may detect a packet at a first interface assigned to a host VLAN (block 510). The process 500 may be implemented by a network device such as a switch having a plurality of interfaces. In an example scenario, at least one first interface of the plurality of interfaces of the switch may be assigned to a host VLAN, and one or more second interfaces may be assigned to a default VLAN. The interfaces may operate as ingress and egress ports for the respective VLANs.

In a number of embodiments, the process 500 may determine that the packet is associated with the host VLAN (block 520). The process may check a destination MAC address contained with the packet to determine whether the packet is associated with the host VLAN. In a variety of embodiments, the process 500 may receive the packet from an upstream network device, such as a Layer 3 device. In an example scenario, the packet may be received as IP directed broadcast, thus enabling a remote network administration server or WOL server to reach endpoints across different or subnets. The packet may be routed through the network as a unicast packet until it reaches the destination subnet. The destination address for an IP directed broadcast may refer to the broadcast address of the destination subnet, for example, 192.168.1.255 for the 192.168.1.0/24 subnet. Upon reaching the switch (that is the destination subnet), the packet may be converted from Layer 3 packet to a Layer 2 broadcast packet and flooded on the destination subnet.

In more embodiments, the process 500 may transmit the packet on the host VLAN (block 530). The host VLAN may include a specific group of endpoints connected to the one or more interfaces of the switch, thus forming a logical broadcast domain. The process 500 may thus transmit the packet on the host VLAN based on the destination MAC address included in the packet.

In additional embodiments, the process 500 may flood the packet on a default VLAN (block 540). Based on the determination that the packet is associated with the host VLAN, the process 500 may flood the packet on the default VLAN. Flooding may refer to a process where a switch transmits or broadcasts a packet to all ports or interfaces within a particular VLAN, for example, the default VLAN. This way the flooded packet may reach all endpoints in the default VLAN. For example, the flooded packet may reach the endpoint that is unauthenticated.

In still additional embodiments, the process 500 may determine whether a response is received from an endpoint that is unauthenticated and coupled to a second interface assigned to the default VLAN (block 545). In a scenario, if there is no endpoint in the default VLAN, the process 500 may not receive any response. However, if the default VLAN includes an authenticated silent host, for example, the silent host may receive the flooded packet and provide a response to the flooded packet. In an example scenario, a WOL server may need to reach the unauthenticated endpoint and thus, the packet may include the destination MAC address for the unauthenticated endpoint. The unauthenticated endpoint upon receiving the packet with its MAC address, may transmit a response to the switch. In numerous embodiments, if the response is not received from an endpoint that is unauthenticated, the process 500 may continue to detect new packets at the first interface assigned to the host VLAN (block 510).

In still more embodiments, if a response is received from the endpoint that is unauthenticated, the process 500 may transmit an authentication request for the endpoint (block 550). The process 500 may transmit the authentication request to an authentication server such as a RADIUS server, Identity Provider (IdP), Authentication, Authorization, and Accounting (AAA) Server, or the like. In yet more embodiments, the process 500 may transmit authentication credentials, corresponding to the unauthenticated endpoint, via protocols such as 802.1X or MAB authentication (typically used for IoT devices). In a typical scenario, the switch implementing the process 500 may forward the authentication credentials to the authentication server via the authentication request.

In still further embodiments, the process 500 may receive an authentication response (block 560). The process 500 may receive the authentication response from the authentication server based on the transmitted authentication request. The authentication response may indicate either a successful authentication or a failed authentication of the endpoint.

In yet more embodiments, the process 500 may determine whether the authentication response indicates a successful authentication of the endpoint (block 565). Upon successful authentication, the process 500 may receive an authentication successful message from the authentication server (for example, a RADIUS Access-Accept message).

In many further embodiments, if the authentication response indicates the successful authentication, the process 500 may assign the second interface to the host VLAN (block 570). Based on the successful authentication of the unauthenticated endpoint, the process 500 may dynamically configure the second interface such that the now authenticated endpoint is moved from the default VLAN to the host VLAN. For example, the RADIUS server may transmit specific attributes in its Access-Accept message for the appropriate VLAN assignment of the endpoint. Thus, when the switch receives the RADIUS attributes, the switch can assign the second interface to the host VLAN.

However, if the authentication response does not indicate a successful authentication of the endpoint, the process 500 may continue operating the second interface on the default VLAN (block 580). If the endpoint is not successfully authenticated, indicating a failed authentication of the endpoint, by the authentication server, the endpoint may continue to operate in the default VLAN, which provides limited access to the endpoint for accessing the network.

Although a specific embodiment showing a process for VLAN assignment for an unauthenticated endpoint suitable for carrying out the various steps, processes, methods, and operations described herein is discussed with respect to FIG. 5, any of a variety of systems and/or processes may be utilized in accordance with embodiments of the disclosure. In several more embodiments, the process 500 may also be implemented by Virtual Extensible LAN (VxLAN), Locator/ID Separation Protocol (LISP) networks. The elements depicted in FIG. 5 may also be interchangeable with other elements of FIGS. 1-4 and 6-8 as required to realize a particularly desired embodiment.

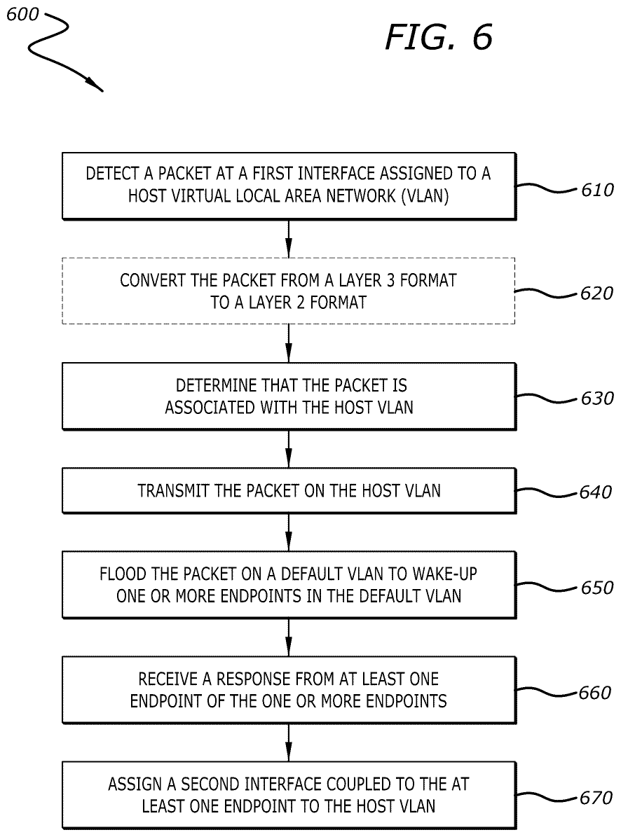

Referring to FIG. 6, a flowchart showing a process 600 for VLAN assignment for a sleeping endpoint in accordance with various embodiments of the disclosure is shown. In many embodiments, the process 600 may detect a packet at a first interface assigned to a host VLAN (block 610). The process 600 may be implemented by a network device such as a switch having a plurality of interfaces. In an example scenario, at least one first interface of the plurality of interfaces of the switch may be assigned to a host VLAN, and one or more second interfaces may be assigned to a default VLAN. The interfaces may operate as ingress and egress ports for the respective VLANs.

In a number of embodiments, the process 600 may optionally convert the packet from a Layer 3 format to a Layer 2 format (block 620). The packet may refer to a WOL packet or any suitable wake-up packets. Considering an example scenario of WOL packets originating from a remote server, since the WOL packet is a Layer 2 (Ethernet) broadcast packet, it does not require an IP address or port. However, when the WOL packet needs to be transmitted over an IP network, such as from the remote server subnet, the WOL packet may need to be wrapped in a Layer 3 (IP) packet or Layer 4 (UDP) packet. Since the WOL packet does not specify a port, network administrators typically use ports 7 and 9 for WOL packets, as these ports do not conflict with other standard network services. In a similar manner, WOL packets may be transmitted as IP Directed Broadcast, which is a Layer 3 broadcast packet. For example, when a Layer 3 IP Directed Broadcast packet sent to 192.168.1.255 on the 192.168.1.0/24 subnet, arrives at a router, the router may convert the Layer 3 broadcast into a Layer 2 broadcast MAC address (FF:FF:FF:FF:FF:FF) and forwards it to the target subnet. In numerous embodiments, the process 600 may receive the Layer 3 packet at an SVI boundary of the switch and may convert the packet from an IP Layer 3 broadcast to a Layer 2 broadcast.

In a variety of embodiments, the process 600 may determine that the packet is associated with the host VLAN (block 630). The process 600 may check how the packet has entered the switch to determine which VLAN the packet is associated with. The host VLAN may include a specific group of endpoints connected to the one or more interfaces of the switch, thus forming a logical broadcast domain. In certain scenarios, the process 600 may check the destination MAC address contained within the packet to determine whether the packet is associated with the host VLAN. In more embodiments, if the packet is an IP directed broadcast, the process 600 may recognize that the packet is addressed to the broadcast address of a specific VLAN. Thus, the process 600 may be able to determine which host VLAN the packet is associated with.

In more embodiments, the process 600 may transmit the packet on the host VLAN (block 640). The process 600 may flood the packet on the host VLAN so that the packet may reach all the authenticated or awake endpoints operating within the host VLAN. In further embodiments, the process 600 may flood the packet on a default VLAN to wake-up one or more endpoints in the default VLAN (block 650). Based on the determination that the packet is associated with the host VLAN, the process 600 may flood the packet on the default VLAN. Thus, the flooded packet may reach all endpoints in the default VLAN, including the endpoint that may be in sleep mode. Examples of the endpoints may include desktops, thin clients, printers, or the like that may be connected as wired end points in an enterprise network. Considering an example scenario, during non-office hours, once employees log out, the endpoints may enter into sleep mode. This may put the endpoints back to the default VLAN from the host VLAN, in order to ensure security of the endpoints. Thus, when the process 600 floods the packet on the default VLAN, one or more endpoints may wake-up based on the information carried in the payload of the packet, such as MAC address of a target endpoint.

In additional embodiments, the process 600 may receive a response from at least one endpoint of the one or more endpoints (block 660). Based on the at least one endpoint receiving the packet, the endpoint may transition from the sleep mode to an active mode. Thus, the process 600 may receive a response from the endpoint that it has transitioned to the active mode. In still more embodiments, the process 600 may assign a second interface coupled to the at least one endpoint to the host VLAN (block 670). Since the at least one endpoint of the one or more endpoints transitioned from the sleep mode to the active mode, the process 600 may re-assign the second interface to the host VLAN.

Although a specific embodiment showing a process for VLAN assignment for a sleeping endpoint suitable for carrying out the various steps, processes, methods, and operations described herein is discussed with respect to FIG. 6, any of a variety of systems and/or processes may be utilized in accordance with embodiments of the disclosure. In several embodiments, the process 600 may check 802.1Q tag in the packet to determine which host VLAN the packet may be associated with. The 802.1Q tag refers to a standard used in Ethernet networks for VLAN tagging, that allows for the identification and segmentation of different networks on the same physical infrastructure. The elements depicted in FIG. 6 may also be interchangeable with other elements of FIGS. 1-5 and 7-8 as required to realize a particularly desired embodiment.

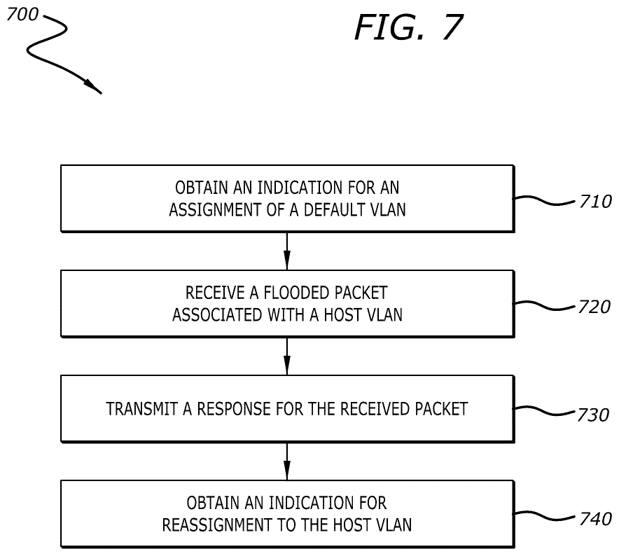

Referring to FIG. 7, a flowchart showing a process 700 for VLAN discovery by an endpoint in accordance with various embodiments of the disclosure is shown. In many embodiments, the process 700 may obtain an indication for an assignment of a default VLAN (block 710). The process 700 may be implemented by an endpoint operating within a VLAN. Examples of the endpoint may include IoT devices, desktops, thin clients, printers, cameras, or other suitable devices. In a number of embodiments, the endpoints may enter into a sleep mode and thus may be assigned to the default VLAN. In a variety of embodiments, if the endpoint is a new IoT device that is still not configured, it may be assigned to the default VLAN. In more embodiments, the endpoint may shutdown, or is faulty thus replaced with another endpoint with a different static IP address, the interface to which the endpoint may be communicatively coupled with, may be assigned to the default VLAN.

In further embodiments, the process 700 may receive a flooded packet associated with a host VLAN (block 720). The process 700 may receive a flooded packet associated the host VLAN at the default VLAN. For example, the endpoint, when assigned to the default VLAN, may receive the flooded packet associated with the host VLAN. The packet may be a WOL packet and thus may include the MAC address of a target endpoint.

In additional embodiments, the process 700 may transmit a response for the received packet (block 730). Considering the above example scenario, when the packet is received by the target endpoint device, the process 700 may transmit a response indicating successful reception of the packet. In still more embodiments, the process 700 may transmit the response for the received packet to a switch having configured the host VLAN and the default VLAN.

In still further embodiments, the process 700 may obtain an indication for reassignment to the host VLAN (block 740). Continuing with the above example scenario, once the endpoint transmits the response for the received packet, the switch may determine that the endpoint is transitioned from the sleep mode to an active mode. In another example, the switch may be able to authenticate the endpoint via an authentication server. Thus, the endpoint may be assigned to an appropriate host VLAN. Therefore, the process 700 may receive an indication from the switch for the re-assignment of the endpoint to the host VLAN.

Although a specific embodiment showing a process for VLAN discovery by an endpoint suitable for carrying out the various steps, processes, methods, and operations described herein is discussed with respect to FIG. 7, any of a variety of systems and/or processes may be utilized in accordance with embodiments of the disclosure. In several embodiments, the process 700 may automatically reassign the endpoint to the host VLAN, if the endpoint reboots and disconnects from the host VLAN. The elements depicted in FIG. 7 may also be interchangeable with other elements of FIGS. 1-6 and 8 as required to realize a particularly desired embodiment.

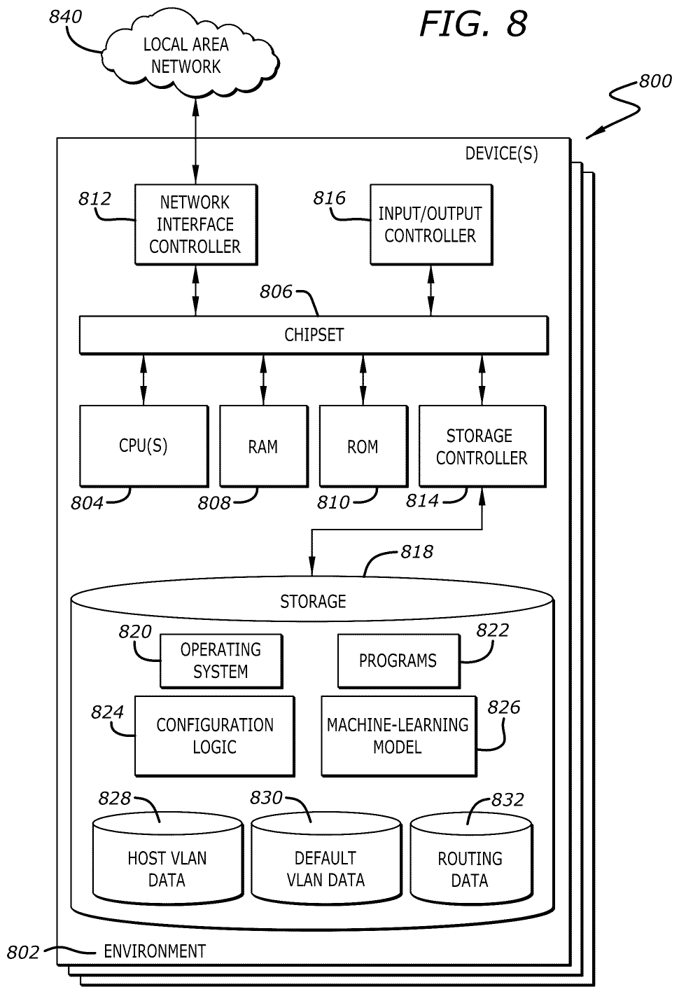

Referring to FIG. 8, a conceptual block diagram of a device 800 suitable for setup with a configuration logic in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many nonlimiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, standard programmable central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface controller (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, host VLAN data 828, default VLAN data 830, and routing data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system 820 comprises the LINUX operating system. According to another embodiment, the operating system 820 comprises the WINDOWS® SERVER operating system from MICROSOFT Corporation of Redmond, Washington. According to further embodiments, the operating system 820 can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer executable instructions may be stored as application 822 and transform the device 800 by specifying how the processor(s) 804 can transition between states, as described above. In some embodiments, the device 800 has access to computer-readable storage media storing computer executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many further embodiments, the device 800 may include a configuration logic 824. The configuration logic 824 can be configured to perform one or more of the various steps, processes, operations, and/or other methods. Often, the configuration logic 824 can be a set of instructions stored within a non-volatile memory that, when executed by the processor(s)/controller(s) 804 can carry out these steps, etc. In some embodiments, the configuration logic 824 may be a client application that resides on a network-connected device, such as, but not limited to, a server, switch, personal or mobile computing device in a single or distributed arrangement.

In some embodiments, the configuration logic 824 can be configured to perform one or more of the various steps, processes, operations, and/or other methods described above in conjunction with FIGS. 1-7 for assigning different interfaces of the device 800 to appropriate VLANs. For example, the configuration logic 824 may assign a first set of interfaces of the plurality of interfaces of the device 800 to a host VLAN. Likewise the configuration logic 824 may assign a second set of interfaces of the interfaces of the device 800 to a default VLAN. The plurality of interfaces may be communicatively coupled to endpoints such as desktops, IoT devices, thin clients, printers, or the like. Thus, the configuration logic 824 may be able to create logical separation of networks for endpoints that may be authenticated and the endpoints that may be unauthenticated or in a sleep mode.

In still more embodiments, the host VLAN data 828 may store information regarding one or more host VLANs configured by the device 800, where each host VLAN may serve a specific group of endpoints connected to the device 800. The host VLAN data 828 may also include information regarding authenticated endpoints that may be operational on the network and the corresponding interfaces through which the endpoints may be communicatively coupled to the device 800.

In still further embodiments, the default VLAN data 830 may store information regarding pre-configured VLAN on the device 800. The default VLAN data 830 may include information regarding the endpoints that may be unauthenticated or may have entered the sleep mode. The default VLAN data 830 may further include information regarding the associated interfaces communicatively coupled with the unauthenticated endpoints.

In still additional embodiments, the routing data 832 may store information using which one or more packets (such as WOL packets) may be forwarded by the device 800. In many embodiments, the routing data 832 may include routing tables including destination network/IP address, subnet mask, next hop, or other such required information. In still more embodiments, the routing data 832 may include routing protocol information, ARP table, routing policies, ACL, or other such relevant information required for routing of a packet.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. In numerous embodiments, the ML model(s) 826 can be utilized to predict VLAN assignment for an endpoint based on the MAC address or IP address of the endpoint.

The ML model(s) 826 can be configured to generate inferences to make predictions or draw conclusions from data. An inference can be considered the output of a process of applying a model to new data. This can occur by learning from at least the host VLAN data 828, the default VLAN data 830 and the routing data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a plurality of interfaces including at least one first interface assigned to a host Virtual Local Area Network (VLAN) and one or more second interfaces assigned to a default VLAN, wherein a second interface of the one or more second interfaces is communicatively coupled to an endpoint that is unauthenticated;
a memory communicatively coupled to the processor, wherein the memory comprises a configuration logic that is configured to:
detect a packet;
determine that the packet is associated with the host VLAN; and
flood the packet on the default VLAN based on the determination that the packet is associated with the host VLAN, wherein based on the flooding, the packet reaches the endpoint that is unauthenticated.

2. The network device of claim 1, wherein the configuration logic is further configured to receive a response from the endpoint based on the packet reaching the endpoint.

3. The network device of claim 2, wherein the configuration logic is further configured to transmit an authentication request for the endpoint to an authentication server.

4. The network device of claim 3, wherein the authentication request is based on MAC-Address Authentication Bypass (MAB).

5. The network device of claim 3, wherein the configuration logic is further configured to receive, in response to the transmitted authentication request, an authentication response from the authentication server.

6. The network device of claim 5, wherein the authentication response is configured to indicate one of a successful authentication of the endpoint or a failed authentication of the endpoint.

7. The network device of claim 6, wherein the configuration logic is further configured to assign the second interface to the host VLAN based on the authentication response indicating the successful authentication of the endpoint.

8. The network device of claim 1, wherein the endpoint is a silent host, incapable of initiating communication until prompted by an external trigger.

9. The network device of claim 1, wherein the packet corresponds to one of: a unicast packet, a broadcast packet, or a Wake-on-LAN (WOL) packet.

10. The network device of claim 1, wherein detecting the packet comprises snooping an Address Resolution Protocol (ARP)-based packet.

11. The network device of claim 1, wherein detecting the packet comprises snooping the packet based on an Access Control List (ACL).

12. The network device of claim 1, wherein prior to detecting, the configuration logic is further configured to receive the packet from an upstream network device.

13. The network device of claim 1, wherein the detected packet is a locally generated packet at the network device.

14. The network device of claim 1, wherein the configuration logic is further configured to transmit the packet on the host VLAN.

15. The network device of claim 1, wherein the host VLAN is an authenticated VLAN and the default VLAN is an unauthenticated VLAN.

16. A network device, comprising:
a processor;
a plurality of interfaces including at least one first interface assigned to a host Virtual Local Area Network (VLAN) and one or more second interfaces assigned to a default VLAN, wherein a second interface of the one or more second interfaces is communicatively coupled to an endpoint that is in a sleep mode;
a memory communicatively coupled to the processor, wherein the memory comprises a configuration logic that is configured to:
detect a packet;
determine that the packet is associated with the host VLAN; and
flood the packet on the default VLAN based on the determination that the packet is associated with the host VLAN, wherein based on the flooding the packet reaches the endpoint that is in the sleep mode.

17. The network device of claim 16, wherein the packet is configured to transition the endpoint from the sleep mode to an active mode.

18. The network device of claim 17, wherein the configuration logic is further configured to:
receive a response from the endpoint that is transitioned to the active mode; and
assign the second interface to the host VLAN based on the response.

19. The network device of claim 16, wherein the endpoint is an 802.1X-enabled device.

20. A method, comprising:
detecting a packet;
determining that the packet is associated with a host Virtual Local Area Network (VLAN) to which at least one first interface of a network device is assigned; and
flooding the packet on a default VLAN based on the determination that the packet is associated with the host VLAN, wherein one or more second interfaces of the network device are assigned to the default VLAN and a second interface of the one or more second interfaces is communicatively coupled to an endpoint that is one of unauthenticated or in a sleep mode, and wherein based on the flooding the packet reaches the endpoint.
